(19) United States
(12) Patent Application Publication
(10) Pub. No.: US 2005/0060660 A1
(43) Pub. Date: Mar. 17, 2005

(54) Display apparatus and control method thereof

(75) Inventor: Hyun-chul Song, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/929,676

(22) Filed: Aug. 31, 2004

(30) Foreign Application Priority Data
Sep. 17, 2003 (KR) 2003-64423

(51) Int. Cl. G06F 3/00

(52) U.S. Cl. 715/781; 345/629

(57) ABSTRACT

A display apparatus has a display displaying a picture thereon, an external input provided with terminals to which connecting jacks of external A/V devices are inserted, an external input recognizer recognizing whether or not the connecting jack of the external A/V device is electrically connected to the terminals of the external input. Also included are an OSD controller; an external input checker; an external input selector; a PIP executor, and a controller. The controller controls the OSD controller to display the A/V input OSD on the display according to information about the connected state of the external A/V device received from the external input recognizer when receives the signal for displaying the A/V input OSD from the external input checker, and controls the PIP executor to display the picture transmitted from the external A/V device connected to the selected terminal in the PIP on the display when a user selects through the external input selector of the terminals shown in the A/V input OSD.

### CROSS-REFERENCE TO RELATED APPLICATION

This application claims the benefit of Korean Patent Application No. 2003-64423, filed Sep. 17, 2003 in the Korean Intellectual Property Office, the disclosure of which is incorporated herein by reference.

### BACKGROUND OF THE INVENTION

1. Field of the Invention

The present invention relates to a display apparatus and a control method thereof, and more particularly, to a display apparatus and a control method thereof, in which a picture of a selected external input is displayed in a PIP (Picture In Picture) when a user selects the external input.

2. Description of the Related Art

Generally, a display apparatus includes an external input provided with various external input terminals. A user can check whether an external A (Audio)/V (Video) device is connected to the external input terminal through an A/V input OSD (On Screen Display) shown in FIG. 5. However, in the conventional display apparatus, the A/V input OSD provides just text information about a connected state between the external A/V device and the external input terminal. The OSD does not provide information about video contents transmitted from the external A/V device. Therefore, a user has to check what kinds of external A/V devices are connected to the display apparatus through the A/V input OSD and then separately check the video contents of the respective external A/V devices through screen conversion, however this process is cumbersome.

Particularly, the more external A/V devices compatible with the display apparatus are added, the more cumbersomeness the process.

### SUMMARY OF THE INVENTION

Accordingly, it is an aspect of the present invention to provide a display apparatus and a control method thereof, in which a picture of a selected external input is displayed in a PIP when a user selects the external input.

Additional aspects and/or advantages of the invention will be set forth in part in the description which follows and, in part, will be obvious from the description, or may be learned by practice of the invention.

The foregoing and other aspects of the present invention are achieved by providing a display apparatus comprising a display displaying a picture thereon, an external input provided with terminals to which connecting jacks of external A/V devices are inserted, an external input recognizer recognizing whether the connecting jack of the external A/V device is electrically connected to the terminal of the external input, an OSD controller controlling an A/V input OSD to be displayed on the display, the A/V input OSD showing a connected state between the respective terminals of the external input and the external A/V device; an external input checker allowing a signal for displaying the A/V input OSD to be generated; an external input selector allowing one of the terminals shown in the A/V input OSD to be selected; a PIP executor displaying a picture in a PIP on the display, the picture being transmitted from the external A/V device connected to the terminal selected through the external input selector; and a controller controlling the OSD controller to display the A/V input OSD on the display according to information about the connected state of the external A/V device received from the external input recognizer when receiving the signal for displaying the A/V input OSD from the external input checker, and controlling the PIP executor to display the picture transmitted from the external A/V device connected to the selected terminal in the PIP on the display when a user selects through the external input selector one of the terminals shown in the A/V input OSD.

According to an aspect of the invention, the display apparatus further comprises a PIP execution selector allowing a user to select whether to operate the PIP executor when a user selects through the external input selector one of the terminals shown in the A/V input OSD, wherein under the condition that the user selects the PIP executor to be not operated through the PIP execution selector, the controller controls the PIP executor to not operate a function that the picture transmitted from the external A/V device through the selected terminal is displayed in the PIP if a user selects through the external input selector one of the terminals shown in the A/V input OSD.

According to another aspect of the present invention, the above and/or other aspects may be also achieved by providing a method of controlling a display apparatus comprising a display displaying a picture thereon, an external input provided with terminals to which connecting jacks of external A/V devices are inserted, an external input recognizer recognizing whether the connecting jack of the external A/V device is electrically connected to the terminal of the external input, the method comprising: generating a signal for displaying an A/V input. OSD showing a connected state between the respective terminals of the external input and the external A/V device; displaying the A/V input OSD on the display; allowing a user to select one of the terminals shown in the A/V input OSD; and displaying a picture in a PIP on the display, the picture being transmitted from the external A/V device connected to the selected terminal.

According to an aspect of the invention, the method further comprises selecting the picture transmitted from the external A/V device connected to the terminal to be not displayed as the PIP when a user selects one of the terminals shown in the A/V input OSD, and controlling the picture transmitted from the external A/V device through the selected terminal to be not displayed in the PIP even if a user selects one of the terminals shown in the A/V input OSD.

According to another aspect of the invention, there is provided a computer readable medium encoded with processing instructions for performing a method of controlling a display apparatus comprising a display displaying a picture thereon, an external input provided with terminals to which connecting jacks of external A/V devices are inserted, an external input recognizer recognizing whether the connecting jacks of the external A/V devices are electrically connected to the terminal of the external input, the method comprising: generating a signal for displaying an A/V input On Screen Display (OSD) showing a connected state between the respective terminals of the external input and the external A/V devices; displaying the A/V input OSD on the display; allowing a user to select one of the terminals shown in the A/V input OSD; and displaying a picture in a PIP on the display, the picture being transmitted from the external A/V devices connected to the selected terminal.

### BRIEF DESCRIPTION OF THE DRAWINGS

These and/or other aspects and advantages of the present invention will become apparent and more readily appreciated from the following description of the embodiments, taken in conjunction with the accompany drawings of which:

FIG. 1 is a block diagram of a display apparatus according to an embodiment of the present invention;

FIG. 2 illustrates an A/V input OSD and an external input PIP selected by a user, which are displayed on a display of the display apparatus according to an embodiment of the present invention;

FIG. 3 is a detailed block diagram of a PIP executor of the display apparatus according to an embodiment of the present invention;

FIG. 4 is a control flowchart of the display apparatus according to an embodiment of the present invention; and

FIG. 5 illustrates an A/V input OSD displayed on a display of a conventional display apparatus.

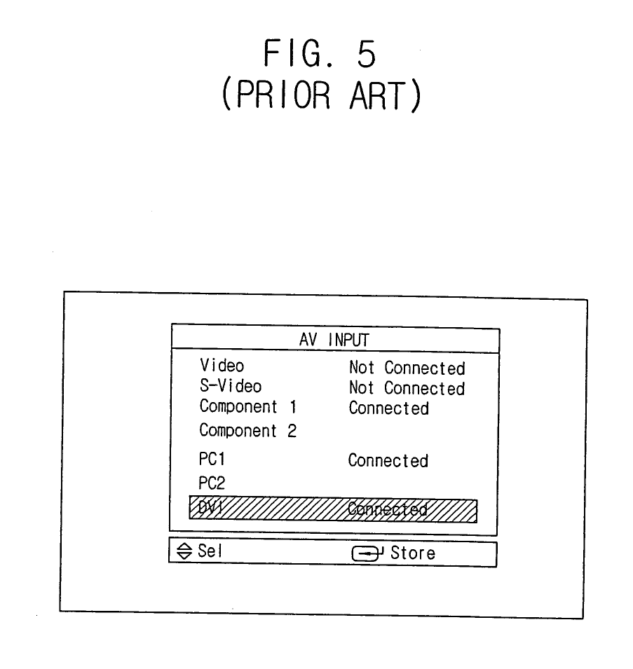

### DETAILED DESCRIPTION OF THE EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

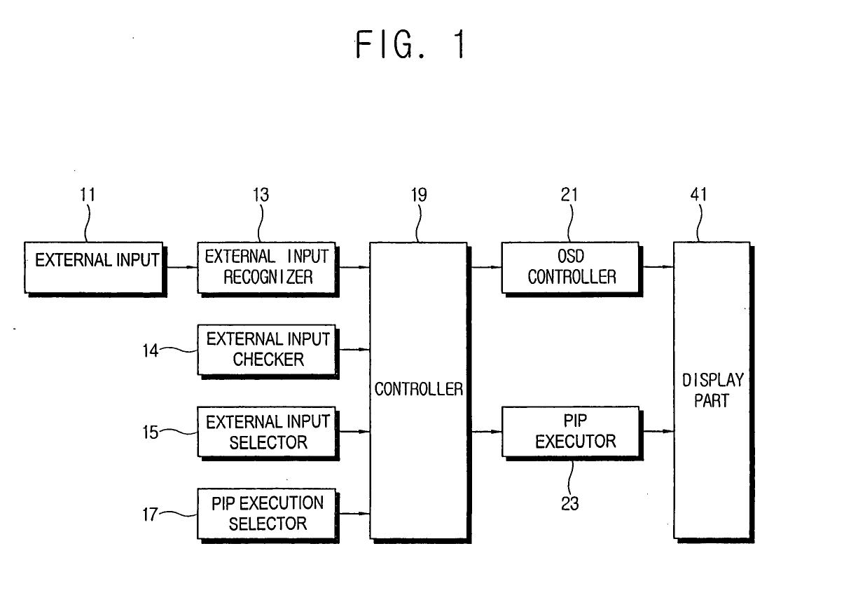

As shown in FIG. 1, a display apparatus according to an embodiment of the present invention comprises an external input 11 provided with terminals to which connecting jacks of external A/V devices (not shown) are inserted. An external input recognizer 13 recognizes whether or not the connecting jack of the external A/V device is electrically connected to the terminal of the external input 11. A display 41 displays a picture from the external A/V device thereon. Also included are an external input selector 15, a PIP execution selector 17, a controller 19, an OSD controller 21, an external input checker 14, and a PIP executor 23.

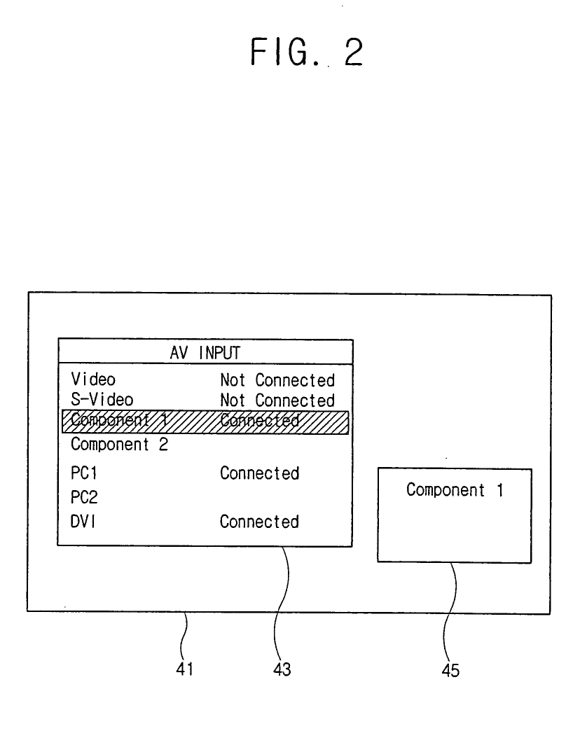

The OSD controller 21 controls an A/V input OSD 43 (shown in FIG. 2) to be displayed on the display 41. The A/V input OSD 43 shows a connected state between the respective terminals of the external input 11 and the external A/V device. A user makes a signal for displaying the A/V input OSD 43 be generated by the external input checker 14 and then selects one of the terminals shown in the A/V input OSD 43 through the external input selector 15. Such a signal can be through any type of input devices such as buttons on the display apparatus or on a remote controller.

The PIP executor 23 displays a picture in a PIP 45 (shown in FIG. 2) on the display 41. The picture is transmitted from the external A/V device connected to the terminal selected through the external input selector 15 for use in the PIP 45.

The external input recognizer 13 recognizes the external A/V device based on a signal transmitted from the connecting jack of the external A/V device connected to the terminal of the external input 11. Here, the external input recognizer 13 includes a signal determining chip, and determines the signal transmitted from the connecting jack of the external A/V devices according to line numbers of the signal. However, it is understood that other mechanisms can be used to determine and recognize the external A/V devices.

The controller 19 controls the OSD controller 21 to display the A/V input OSD 43 on the display 41 when receiving the signal for displaying the A/V input OSD 43 from the external input checker 14, based on information about the connected state of the external A/V device received from the external input recognizer 13. Further, the controller 19 controls the PIP executor 23 to display a picture in the PIP 45 on the display 41 when a user selects the corresponding one of the terminals shown in the A/V input OSD 43 through the external input selector 15, wherein the picture is transmitted from the external A/V device connected to the selected terminal. Thus, the display apparatus according to an embodiment of the present invention provides information about the picture received from the external A/V device as well as the connected state of the external A/V device, thereby facilitating a user's selection of the external input.

Here, a user can select through the PIP execution selector 17 whether to operate the PIP executor 23 when one of the terminals shown in the A/V input OSD 43 is selected. When a user selects through the PIP execution selector 17 the PIP executor 23 not to operate, the controller 19 controls the PIP executor 23 to not operate, so that the picture transmitted through the selected terminal is not displayed in the PIP 45 (refer to FIG. 2) even if a user selects one of the terminals shown in the A/V input OSD 43.

Thus, under the condition that the PIP executor 23 is selected to not operate, when a user selects through the external input selector 15 a component terminal to which a component jack is connected, the picture transmitted through the component terminal is not displayed in the PIP 45.

For example, when the signal determining chip stores its register with a horizontal scanning line signal 1080i transmitted through the component jack connected to the component terminal provided in the external input 11, the external input recognizer 13 determines that a component device is connected to the display apparatus. In this state, when a user makes the signal for displaying the A/V input OSD 43 be generated by the external input checker 14 including an input key, etc., the controller 19 receives the signal for displaying the A/V input OSD 43. Also, the controller 19 controls the OSD controller 21 to display the A/V input OSD 43 on the display 41, wherein the A/V input OSD 43 contains information about the connected state of the component device. Further, when a user selects through the external input selector 15 the component terminal among the external input terminals shown in the A/V input OSD 43, the controller 19 controls the picture transmitted from the component device to be displayed as the PIP 45 on the display 41.

The PIP executor 23 comprises a scaler or a video decoder according to an aspect of the invention. However, it is understood that other mechanisms could be used.

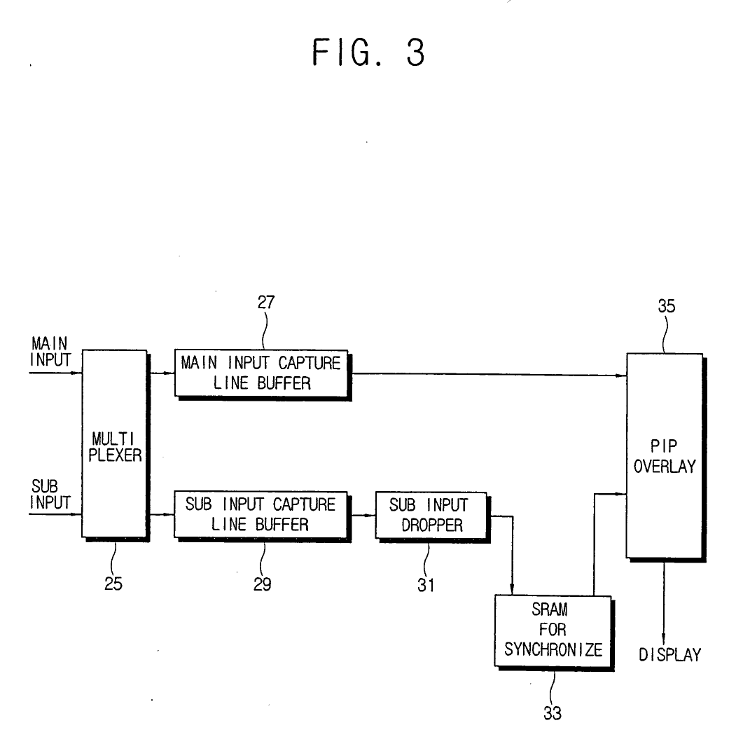

For example, as shown in FIG. 3, when the PIP is executed through the scaler by letting a PC (Personal Computer) line be a main input and a video line be a sub input, the PIP executor 23 comprises a multiplexer 25, a main input capture line buffer 27 as a PC capture line buffer, a sub input capture line buffer 29 as a video capture line buffer, a sub input pixel dropper 31 as a video pixel dropper, a SRAM (Static Random Access Memory) 33, and a PIP overlay 35.

The multiplexer 25 divides a video signal into a main input video signal and a sub input video signal and transmits them to the main and sub input capture line buffers 27 and 29, respectively. The main input capture line buffer 27 receives the main input video signal and transmits the signal to the PIP overlay 35. Further, the sub input capture line buffer 29 receives the sub input video signal and transmits the signal to the sub input pixel dropper 31. The sub input pixel dropper 31 drops the number of pixels to decrease the size of the picture due to the sub input video signal. After passing through the sub input pixel dropper 31, the sub input video signal is transmitted to the SRAM 33, thereby being synchronized with the main input video signal. Here, the sub input video signal and the main input video signal are preferably synchronized by a PLL (Phase Lock Loop) technology. Thereafter, the main and sub input video signals are transmitted to and are synthesized by the PIP overlay 35, so that the pictures due to the main and sub inputs are displayed as the PIP on the display 41.

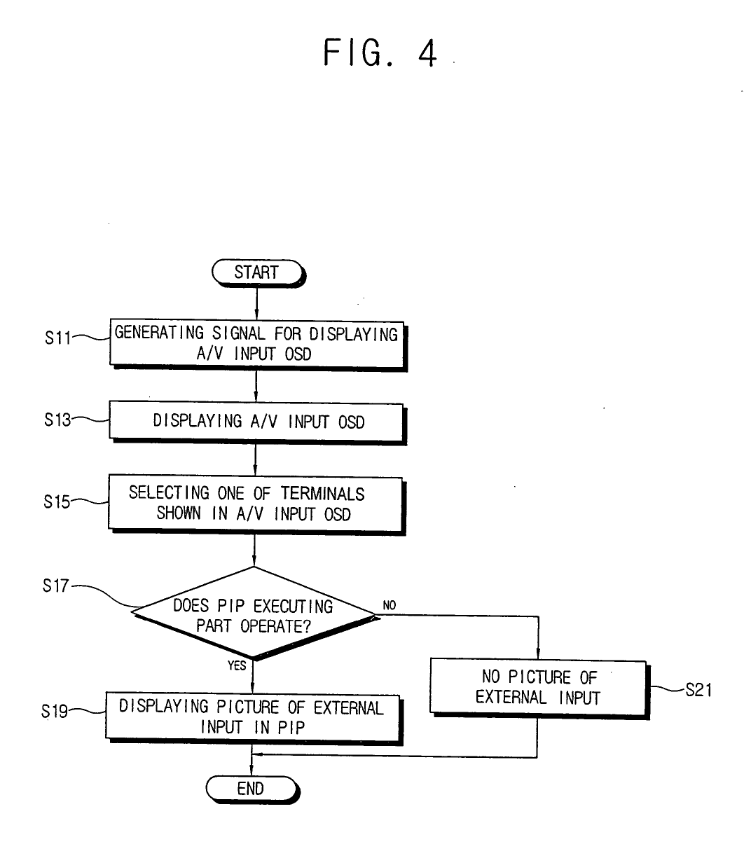

Hereinbelow, the operation of the display apparatus according to an embodiment of the present invention will be described with reference to FIG. 4.

At operation S11, a user makes the signal for displaying the A/V input OSD 43 to show the information about the connected state between the respective terminals of the external input 11 and the external A/V device generated by the external input checker 14 including an input key, etc.

At operation S13, the controller 19 controls the OSD controller 21 to display the A/V input OSD 43 on the display 41, on the basis of information on the connected state of the external A/V device received from the external input recognizer 13.

At operation S15, a user selects one of the terminals shown in the A/V input OSD 43 through the external input selector 15.

Simultaneously, at operation S17, a user may determine whether the PIP executor 23 is operated when one of the terminals shown in the A/V input OSD 43 is selected.

In the case where it is determined that the PIP executor 23 is operated, at operation S19, the controller 19 controls the PIP executor 23 to display a picture in the PIP on the display 41, wherein the picture is transmitted from the external A/V device connected to the selected terminal.

For example, if the A/V input OSD 43 displayed on the display 41 shows the connected state of the component terminal, a user can select through the external input selector 15 the component terminal among the external input terminals shown in the A/V input OSD 43. When a user selects the component terminal, the controller 19 controls the PIP executor 23 to display the picture received from the component device in the PIP 45 on the display 41. Thus, the display 41 displays the picture received from the component device as the PIP 45.

Oppositely, when it is determined that a user selects through the PIP execution selector 17 the PIP executor 23 not to operate, at operation S21, the controller 19 controls the PIP executor 23 to not operate, so that the picture transmitted from the external A/V device through the selected terminal is not displayed in the PIP 45 even if a user selects through the external input selector 15 one of the terminals shown in the A/V input OSD 43.

As described above, the present invention provides a display apparatus and a control method thereof, in which a picture of a selected external input is displayed in a PIP when a user selects the external input.

The aforementioned method of controlling a display apparatus shown in FIG. 4 may be embodied as a computer program that can be run by a computer, which can be a general or special purpose computer. Thus, it is understood that the display apparatus can be such a computer. Computer programmers in the art can easily reason codes and code segments, which constitute the computer program. The program is stored in a computer readable medium readable by the computer. When the program is read and run by a computer, the method of controlling the display apparatus is performed. Here, the computer-readable medium may be a magnetic recording medium, an optical recording medium, a carrier wave, firmware, or other recordable media.

Additionally, while described as being received in terminals of the external input 11, it is understood that the present invention can be used with devices connected to the display apparatus across a network, such as wired or wireless networks. Moreover, it is understood that the PIP could display video or text data only, or output audio data only so as to distinguish different audio input. Lastly, it is understood that more than A/V devices can be connected to the display apparatus, and that output of other devices, such as personal computers and/or intelligent appliances, could be viewed in the PIP.

Although a few embodiments of the present invention have been shown and described, it will be appreciated by those skilled in the art that changes may be made in these embodiments without departing from the principles and spirit of the invention, the scope of which is defined in the appended claims and their equivalents.

1. An apparatus for use in a display apparatus comprising: a display displaying a picture thereon; an external input having terminals to which connecting jacks of external A/V devices are inserted, and an external input recognizer recognizing whether or not the connecting jacks of the external A/V devices are electrically connected to the terminals of the external input; the apparatus comprising:
an On-Screen Display (OSD) controller controlling an A/V input OSD to be displayed on the display, the displayed A/V input OSD showing a connected state between the terminals of the external input and the external A/V devices;
an external input checker allowing a signal for displaying the A/V input OSD to be generated;
an external input selector allowing one of the terminals of the external input shown in the A/V input OSD to be selected;
a PIP executor displaying a picture in a Picture-in-Picture (PIP) on the display, the picture being transmitted from the external A/V devices connected to the terminals of the external input selected through the external input selector; and
a controller controlling the OSD controller to display the A/V input OSD on the display according to information about the connected state of the external A/V devices received from the external input recognizer when receiving the signal for displaying the A/V input OSD from the external input checker, and controlling the PIP executor to display the picture transmitted from the external A/V devices connected to the selected terminal in the PIP on the display when a user selects through the external input selector one of the terminals shown in the A/V input OSD.

2. The apparatus according to claim 1, further comprising a PIP execution selector allowing the user to select whether to operate the PIP executor when the user selects through the external input selector one of the terminals shown in the A/V input OSD,
wherein when the user selects the PIP executor not to be operated through the PIP execution selector, the controller controls the PIP executor to not operate a function where the picture transmitted from the external A/V device through the selected terminal is displayed in the PIP if the user selects through the external input selector one of the terminals shown in the A/V input OSD.

3. The apparatus according to claim 2, wherein the external input recognizer includes a signal determining chip and determines a signal transmitted from the connecting jacks of the external A/V devices to the terminals of the external input according to line numbers of the signal.

4. The apparatus according to claim 1, wherein the display apparatus provides information about the picture received from the external A/V devices as well as the connected state of the external A/V devices.

5. A method of controlling a display apparatus comprising a display displaying a picture thereon, an external input having with terminals to which connecting jacks of external A/V devices are inserted, an external input recognizer recognizing whether the connecting jacks of the external A/V devices are electrically connected to the terminals of the external input, the method comprising:
generating a signal for displaying an A/V input On Screen Display (OSD) showing a connected state between the terminals of the external input and the corresponding external A/V devices;
displaying the A/V input OSD on the display;
receiving a selection to select one of the terminals shown in the A/V input OSD; and
displaying a picture in a picture-in-picture (PIP) on the display, the picture being transmitted from the external A/V devices connected to the selected terminal.

6. The method according to claim 5, further comprising selecting a mode in which the picture transmitted from the external A/V device connected to the terminal not to be displayed as the PIP when one of the terminals shown in the A/V input OSD is selected, and
if the mode is selected, controlling the picture transmitted from the external A/V device through the selected terminal not to be displayed in the PIP even if one of the terminals shown in the A/V input OSD is selected.

7. The method according to claim 5, further comprising displaying information about the picture received from the external A/V devices as well as the connected state of the external A/V devices.

8. A computer readable medium encoded with processing instructions for performing a method of controlling a display apparatus performed by a computer associated with the display apparatus, the display apparatus comprising a display displaying a picture thereon, an external input provided with terminals having connecting jacks where external A/V devices are inserted, an external input recognizer recognizing whether the connecting jacks of the external A/V devices are electrically connected to the terminals of the external input, the method comprising:
generating a signal for displaying an A/V input On Screen Display (OSD) showing a connected state between the respective terminals of the external input and the external A/V devices;
controlling the display to display the A/V input OSD on the display;
receiving a selection selecting one of the terminals shown in the displayed A/V input OSD; and
controlling the display to display a picture in a picture-in-picture (PIP) on the display, the picture being transmitted from the external A/V devices connected to the selected terminal.

9. The computer readable medium according to claim 8, wherein the method further comprises selecting a mode in which the picture transmitted from the external A/V device connected to the terminal not to be displayed as the PIP when one of the terminals shown in the A/V input OSD is selected, and
if the mode is selected, controlling the picture transmitted from the external A/V device through the selected terminal not to be displayed in the PIP even if one of the terminals shown in the A/V input OSD is selected.

10. A display apparatus comprising:
a display displaying a picture thereon;
an On-Screen Display (OSD) controller controlling an input OSD to be displayed on the display, the input OSD showing a connected state of external devices and the display;
an external input selector allowing one of the connected external devices shown in the input OSD to be selected;
a Picture-in-Picture (PIP) executor displaying a picture in a PIP on the display, the picture being transmitted from one the external devices selected through the external input selector; and
a controller controlling the OSD controller to display the input OSD on the display, and controlling the PIP executor to display the picture transmitted from the selected external device in the PIP on the display according to a selection received through the external input selector.

11. The display apparatus according to claim 10, further comprising a PIP execution selector allowing another selection to select whether to operate the PIP executor when the selection of one of the external devices is received through the external input selector.

12. The display apparatus according to claim 11, wherein when the PIP executor is selected not to be operated through the PIP execution selector, the controller controls the PIP executor not to operate a function where the picture transmitted from the external devices through the selected terminal is displayed in the PIP if a user selects through the external input selector one of the terminals shown in the A/V input OSD.

13. The display apparatus according to claim 10, further comprising an external input having terminals; and an external input recognizer recognizing whether connecting jacks of the external devices are connected to the terminals of the external input.

14. The display apparatus according to claim 13, wherein the external input recognizer includes a signal determining chip and recognizes a signal transmitted from the connecting jacks to the terminals according to line numbers of the signal.

15. The display apparatus according to claim 10, wherein the display apparatus provides information about the picture received from the external devices as well as the connected state of the external devices.

16. The display apparatus according to claim 1, wherein the PIP executor includes a scaler or a video decoder.

17. The display apparatus according to claim 10, wherein the PIP executor includes a scaler or a video decoder.

18. The display apparatus according to claim 1, wherein the PIP comprises a multiplexer connected to a main input capture line buffer and to a sub input capture line buffer, a sub input pixel dropper connected to the sub input capture line buffer and to a SRAM and a PIP overlay connected to the main input capture line buffer and to the SRAM.

19. The display apparatus according to claim 10, wherein the PIP comprises a multiplexer connected to a main input capture line buffer and to a sub input capture line buffer, a sub input pixel dropper connected to the sub input capture line buffer and to a SRAM and a PIP overlay connected to the main input capture line buffer and to the SRAM.

20. The display apparatus according to claim 18, wherein the multiplexer divides a video signal into a main input video signal and a sub input video signal and transmits the video and sub input video signals to the main and sub input capture line buffers, respectively.

21. The display apparatus according to claim 19, wherein the multiplexer divides a video signal into a main input video signal and a sub input video signal and transmits the video and sub input video signals to the main and sub input capture line buffers, respectively.
